(19) United States
(12) Patent Application Publication
(10) Pub. No.: US 2014/0044940 A1
(43) Pub. Date: Feb. 13, 2014

(54) OPTICAL RECORDING MEDIUM AND METHOD FOR MANUFACTURING OPTICAL RECORDING MEDIUM

(71) Applicant: Sony Corporation, Tokyo (JP)

(72) Inventors: Tomoya Ikuta, Kanagawa (JP); Fumisada Maeda, Tokyo (JP); Kimihiro Saito, Kanagawa (JP); Takashi Nakao, Tokyo (JP); Takahiro Miura, Kanagawa (JP); Yoshiaki Sakakura, Kanagawa (JP); Yojiro Sumi, Kanagawa (JP)

(73) Assignee: Sony Corporation, Tokyo (JP)

(21) Appl. No.: 13/957,244

(22) Filed: Aug. 1, 2013

(30) Foreign Application Priority Data
Aug. 8, 2012 (JP) 2012-176227

(51) Int. Cl. G11B 7/2572; G11B 7/26

(52) U.S. Cl. CPC G11B 7/2572; G11B 7/26
USPC 428/213; 428/523; 156/249

(57) ABSTRACT

An optical recording medium includes a first transparent film layer, a second transparent film layer, and a recording material layer sandwiched between the first transparent film layer and the second transparent film layer. The recording material layer includes a hologram recording material.

### BACKGROUND

The present disclosure relates to an optical recording medium and a method for manufacturing an optical recording medium.

In recent years, optical recording media, such as optical disks, used for recording and reproducing data using a hologram technology (holography) have been extensively developed. Such optical disks are expected to have a significantly larger capacity than existing optical disks, such as digital versatile discs (DVDs) or Blu-ray Discs (BDs) (trade name).

A variety of technologies relating to optical disks using holography have been developed (refer to, for example, Japanese Unexamined Patent Application Publication Nos. 2011-107182, 2011-107181, 2011-70715, 2011-96293, and 2011-14199).

### SUMMARY

Optical recording media that record data using holography are expected to have a hologram stably formed in a hologram recording material layer.

Accordingly, the present disclosure provides an optical recording medium that allows a hologram to be stably formed therein and a method for manufacturing the optical recording medium.

According to an embodiment of the present technology, an optical recording medium includes a first transparent film layer, a second transparent film layer, and a recording material layer sandwiched by the first transparent film layer and the second transparent film layer, where the recording material layer includes a hologram recording material.

According to another embodiment of the present technology, a method for manufacturing an optical recording medium includes forming a first transparent film layer forming base material by bonding a first transparent film layer to one of principal surfaces of a first base material with a first adhesion layer therebetween, forming a second transparent film layer forming base material by bonding a second transparent film layer to one of principal surfaces of a second base material with a second adhesion layer therebetween, forming a recording material layer including a hologram recording material between the principal surface of the first transparent film layer forming base material adjacent to the first transparent film layer and the principal surface of the second transparent film layer forming base material adjacent to the second transparent film layer, forming, after the recording material layer is formed, a member having the recording material layer formed between the first transparent film layer and the second transparent film layer by de-bonding a first adhesion interface between the first transparent film layer and the first adhesion layer and de-bonding a second adhesion interface between the second transparent film layer and the second adhesion layer, and bonding the member to one of principal surfaces of a base plate.

According to the present technology, by sandwiching the recording material layer between the first transparent film layer and the second transparent film layer, the flatness of the recording material layer can be maintained. As a result, a stable hologram can be formed.

### BRIEF DESCRIPTION OF THE DRAWINGS

FIG. 1 is a schematic cross-sectional view of an example of the configuration of an optical recording medium according to a first exemplary embodiment of the present technology;

FIGS. 2A to 2C are schematic cross-sectional views illustrating a method for manufacturing an optical recording medium;

FIGS. 3A to 3D are schematic cross-sectional views illustrating the method for manufacturing an optical recording medium; and

FIGS. 4A to 4C are schematic cross-sectional views illustrating a method for manufacturing an optical recording medium.

### DETAILED DESCRIPTION OF EMBODIMENTS

Exemplary embodiments of the present technology are described below with reference to the accompanying drawings. Note that descriptions are made in the following order:
1. First Exemplary Embodiment (Example of Configuration of Optical Recording Medium), and
2. Other Exemplary Embodiments (Modifications).
   In addition, in all drawings of the exemplary embodiments, the same reference symbols are used for the same or similar elements.

### 1. First Exemplary Embodiment

### (Example of Configuration of Optical Recording Medium)

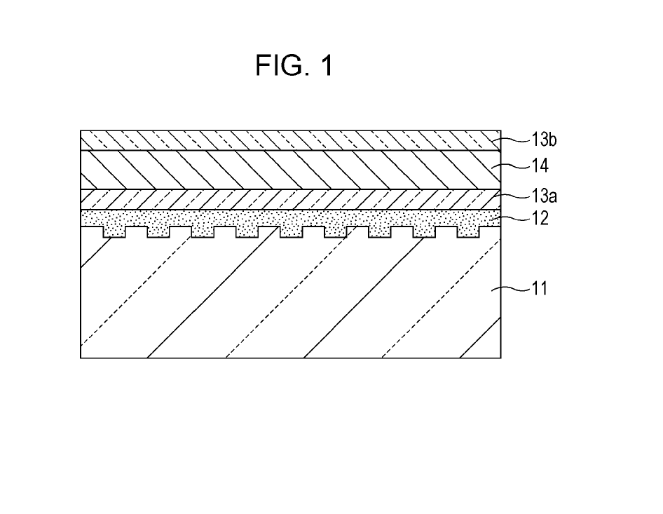

An example of the configuration of an optical recording medium according to a first exemplary embodiment of the present technology is described below. FIG. 1 is a schematic cross-sectional view of an example of the configuration of the optical recording medium according to the first exemplary embodiment of the present technology. As illustrated in FIG. 1, the optical recording medium has a structure including an adhesion layer 12, a first transparent film layer 13a, a recording material layer 14, and a second transparent film layer 13b stacked on a base plate 11 in this order.

For example, the optical recording medium is a disc-shaped optical recording medium (an optical disk) having an opening at the center. For example, by emitting a laser beam onto the recording material layer 14 and generating a recording mark, data can be recorded in the optical recording medium. In addition, by emitting a laser beam onto the recording material layer 14, the recorded data can be reproduced. For example, the optical recording medium is an optical recording medium used for recording and reproducing data using a hologram technology (holography).

The base plate 11, the adhesion layer 12, the first transparent film layer 13a, the recording material layer 14, and the second transparent film layer 13b that constitute the optical recording medium are sequentially described below.

### (Base Plate)

For example, the base plate 11 has a disc shape, and the disc has an opening at the center. For example, a plastic material (e.g., polycarbonate series resin, polyolefin series resin, or acrylic-type resin) or glass can be used as the material of the base plate 11.

One of the two principal surfaces of the base plate 11 has the following layers formed thereon: the first transparent film layer 13a, the second transparent film layer 13b, and the recording material layer 14 sandwiched between the first transparent film layer 13a and the second transparent film layer 13b. The first transparent film layer 13a is bonded to the base plate 11 with the adhesion layer 12 therebetween. In this manner, the rigidity of the recording material layer 14 sandwiched by the first transparent film layer 13a bonded to the base plate 11 and the second transparent film layer 13b can be further increased.

The principal surface of the base plate 11 is, for example, a bumpy surface. Although not illustrated, a reflecting surface is formed on the bumpy surface. The bumpy surface is formed from a guide groove for indicating the recording or reproducing position. The entire guide groove is a variety of forms in shape, such as a spiral or a concentric circle when viewed from the principal surface of the optical recording medium.

The guide groove can be formed as a continuous groove, a pit string, or a combination of a groove and a pit string. In order to stabilize the linear speed and provide address information, such as positional information (e.g., rotation angle information or radius position information), the guide groove may wobble.

### (Selective Reflection Layer)

Although not illustrated, a selective reflection layer is provided on the side of the bumpy surface of the base plate 11. In the optical recording medium according to the present exemplary embodiment, in addition to a recording beam (a first laser beam) for performing mark recording on the recording material layer 14, a servo beam (a second laser beam), for example, is emitted onto the selective reflection layer in order to obtain a tracking error signal and a focus error signal on the basis of the guide groove of the base plate 11. When a recording beam is emitted and if the recording beam is reflected or absorbed by the selective reflection layer, the amount of recording beam reaching the inside of the recording material layer is attenuated and, thus, the effective recording sensitivity decreases. Accordingly, it is desirable that the selective reflection layer have a selectivity such that a servo beam is reflected and a nearly all the recording beam is transmitted.

For the optical recording medium, for example, laser beams having different wavelengths are used as a recording beam and a servo beam. For example, the selective reflection layer has a selectivity such that light in a wavelength range that is the same as the wavelength range of the servo beam is reflected and light having the other wavelength range (e.g., the recording beam) is transmitted.

For example, a film stack in which a plurality of low refractive index films and a plurality of high refractive index films are alternately stacked can be used as the selective reflection layer. For example, a dielectric film can be used as each of the low refractive index film and the high refractive index film. Examples of the material of the dielectric film include silicon nitride, oxide silicon, tantalum oxide, titanium oxide, magnesium fluoride, and zinc oxide.

### (Adhesion Layer)

For example, a pressure sensitive adhesive (PSA) or a light cure adhesive, such as HPSA (a sheet UV-curable PSA) can be used as an adhesive that forms the adhesion layer 12.

### (Recording Material Layer)

The recording material layer 14 includes a hologram recording material that can record a hologram. A typical example of a hologram recording material is photopolymer. For example, the photopolymer is a photopolymerizable photopolymer. For example, in an initial state, the photopolymerizable photopolymer contains monomers uniformly dispersed in a matrix polymer. Note that the photopolymerizable photopolymer may contain a photopolymerization initiator in addition to the monomers and matrix polymer. A photopolymerizable photopolymer has a characteristic so that if light is emitted, monomers present in a portion onto which the light is emitted polymerize into polymer and, thus, the refractive index varies.

In the recording material layer 14, data is recorded using a recording mark, for example. To record data, a negative micro-hologram method can be typically employed. That is, a pre-constructed hologram is erased by emitting a laser beam, and the erased portion serves as a recording mark. In the negative micro-hologram method, before a recording operation starts, an initialization process is performed on the recording material layer 14 so that a hologram (a fringe pattern) is formed in advance. After the fringe pattern is formed through the initialization process in advance, information is recorded by forming an erase mark. An erase mark is formed by, for example, focusing a laser beam at a desired position in the recording material layer 14 and emitting the laser beam in accordance with information to be recorded. For example, volumetric recording is performed on the recording material layer 14 so that a plurality of layers each having an erase mark and serving as a data recording layer are formed.

Note that the data recording method is not limited to a negative micro-hologram method. For example, a variety of recording methods, such as a positive micro-hologram method, can be employed. In a positive micro-hologram method, a hologram (a fringe pattern) that serves as a recording mark is formed in a recording material layer.

### (First Transparent Layer and Second Transparent Layer)

The first transparent film layer 13a and the second transparent film layer 13b sandwich a pair of the principal surfaces of the recording material layer 14. Thus, the first transparent film layer 13a covers one of the two principal surfaces of the recording material layer 14, and the second transparent film layer 13b covers the other principal surface.

By sandwiching the recording material layer 14 between the first transparent film layer 13a and the second transparent film layer 13b, deformation of the recording material layer 14 due to internal stress caused by, for example, hardening and contraction of the recording material layer 14 can be prevented. Thus, the flatness of the recording material layer 14 can be maintained. In addition, exposure of the recording material layer 14 to oxygen can be prevented.

For example, by maintaining the flatness of the recording material layer 14 and preventing the recording material layer 14 from being exposed to oxygen before a hologram is formed in the recording material layer 14, a stable hologram (a diffracting grating) can be formed. In addition, by maintaining the flatness of the recording material layer 14 after a hologram is formed in the recording material layer 14, deterioration of hologram diffraction efficiency can be reduced. By sandwiching the recording material layer 14 between the first transparent film layer 13a and the second transparent film layer 13b in this manner, a stable hologram can be formed and deterioration of a hologram (e.g., deterioration of the diffraction efficiency) can be reduced. As a result, the hologram can have good keeping quality.

In order to more excellently maintain the flatness of the recording material layer 14, it is desirable that, for example, the first transparent film layer 13a and the second transparent film layer 13b have the same or substantially the same thickness.

If the first transparent film layer 13a and the second transparent film layer 13b have the same or substantially the same thickness, deformation of the recording material layer 14 in the thickness direction can be made more uniform. Accordingly, the flatness of the recording material layer 14 can be more excellently maintained. That is, the surface of the recording material layer 14 adjacent to the first transparent film layer 13a is bonded and fixed to the base plate 11 with the first transparent film layer 13a therebetween. Accordingly, the deformability is low. In contrast, since the surface of the recording material layer 14 adjacent to the second transparent film layer 13b is not bonded and fixed to the base plate 11, the deformability is higher than that of the side of the recording material layer 14 adjacent to the first transparent film layer 13a. However, such a difference in deformability of the recording material layer 14 in the thickness direction can be eliminated by making the thicknesses of the first transparent film layer 13a and the second transparent film layer 13b the same or substantially the same. As a result, the flatness of the recording material layer 14 can be more excellently maintained.

In order to maintain the servo performance, it is desirable that the first transparent film layer 13a and the second transparent film layer 13b be low-birefringent transparent resin films. In addition, it is desirable that the first transparent film layer 13a and the second transparent film layer 13b have a resistance to the material of the recording material layer 14 (e.g., the recording material layer 14 and each of the first transparent film layer 13a and the second transparent film layer 13b have low mutual solubility). Furthermore, it is desirable that each of the first transparent film layer 13a and the second transparent film layer 13b have high adhesion to the recording material layer 14. Still furthermore, it is desirable that each of the first transparent film layer 13a and the second transparent film layer 13b have high peelability from a film adhesion layer 21a and a film adhesion layer 21b (described in more detail below). Yet still furthermore, it is desirable that the first transparent film layer 13a and the second transparent film layer 13b have low transmitted wavefront aberration. Yet still furthermore, in order to prevent stray light, it is desirable that a difference in the index of refraction among the first transparent film layer 13a, the recording material layer 14, and the second transparent film layer 13b be small.

It is more desirable that the first transparent film layer 13a and the second transparent film layer 13b be low birefringent and have resistance to the material of the recording material layer 14, high adhesion to the recording material layer 14, and high peerability from an adhesion layer 21 during a manufacturing process. An example of each of the first transparent film layer 13a and the second transparent film layer 13b is a transparent resin film, such as ARTON® film available from JSR Corporation.

### Method for Manufacturing Optical Recording Medium First Example of Method for Manufacturing Optical Recording Medium

A first example of a method for manufacturing an optical recording medium according to a first exemplary embodiment of the present technology is described next. For example, the first example of a method for manufacturing an optical recording medium is employed when manufacturing an optical recording medium that uses a negative micro-hologram method as a data recording method.

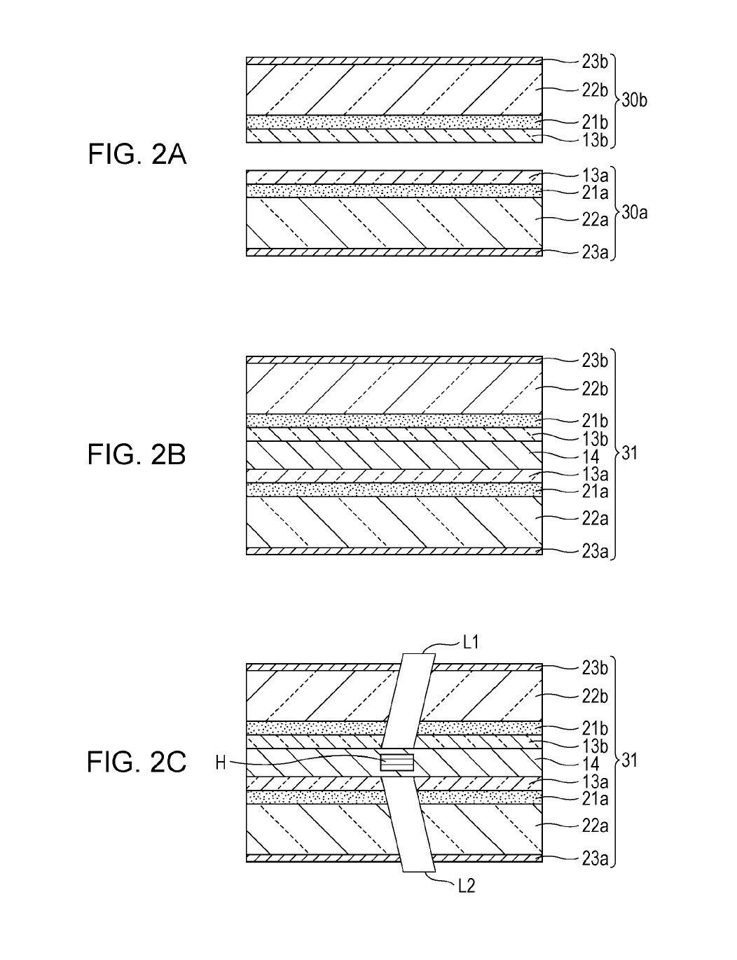

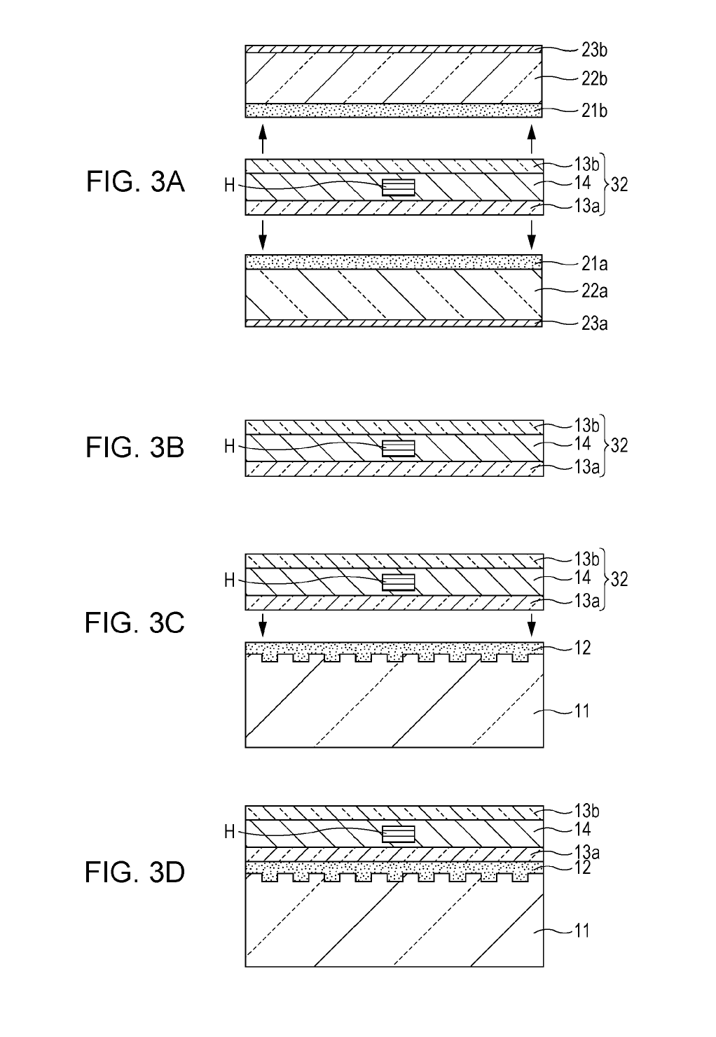

FIGS. 2A to 2C and FIGS. 3A to 3D are schematic cross-sectional views illustrating the method for manufacturing an optical recording medium. The method for manufacturing an optical recording medium is described below with reference to FIGS. 2A to 2C and FIGS. 3A to 3D.

### (Formation of Transparent Film Layer Base Material)

As illustrated in FIG. 2A, a first transparent film layer forming base material 30a is formed first. For example, after an anti-reflection film 23a is formed on one of the principal surfaces of a transparent base material 22a, the film adhesion layer 21a is formed on the other principal surface of the transparent base material 22a and, thereafter, the first transparent film layer 13a is formed on top of the film adhesion layer 21a. In this manner, the first transparent film layer forming base material 30a is formed.

Similarly, a second transparent film layer forming base material 30b is formed. For example, after an anti-reflection film 23b is formed on one of the principal surfaces of a transparent base material 22b, the film adhesion layer 21b is formed on the other principal surface of the transparent base material 22b and, thereafter, the second transparent film layer 13b is formed on the film adhesion layer 21b. In this manner, the second transparent film layer forming base material 30b is formed.

Each of the transparent base material 22a and the transparent base material 22b has, for example, a disk-shape having an opening at the center. The transparent base material 22a and the transparent base material 22b are transparent. A material having rigidity that is higher than that of the recording material layer 14 is selected as the transparent base material 22a and the transparent base material 22b. In this manner, deformation of the recording material layer 14 can be prevented. For example, each of the transparent base material 22a and the transparent base material 22b has a thickness that is sufficiently greater than that of the recording material layer 14 and, thus, has rigidity that is higher than that of the recording material layer 14. Alternatively, the transparent base material 22a and the transparent base material 22b are formed from a material having rigidity that is higher than that of the recording material layer 14 and, thus, have rigidity that is higher than that of the recording material layer 14. Still alternatively, each of the transparent base material 22a and the transparent base material 22b has a thickness that is sufficiently greater than that of the recording material layer 14 and, in addition, the transparent base material 22a and the transparent base material 22b are formed from a material having rigidity that is higher than that of the recording material layer 14. In this manner, each of the transparent base material 22a and the transparent base material 22b can have rigidity that is higher than that of the recording material layer 14. An example of the material of the transparent base material 22a and the transparent base material 22b is a transparent base material such as a glass base plate. In order to maintain sufficient rigidity, it is desirable that the glass base plate be thicker than the recording material layer 14.

For example, each of the film adhesion layer 21a and the film adhesion layer 21b is formed from a pressure sensitive adhesive (PSA) or a light cure adhesive, such as HPSA (a sheet UV-curable PSA).

### (Formation of Recording Material Layer)

Subsequently, as illustrated in FIG. 2B, a structure 31 having the recording material layer 14 sandwiched between the first transparent film layer forming base material 30a and the second transparent film layer forming base material 30b is formed. For example, the structure 31 has a disc-shape. Note that the recording material layer 14 is, for example, 150 μm in thickness. Each of the first transparent film layer 13a and the second transparent film layer 13b is, for example, 48 μm in thickness. Each of the transparent base material 22a and the transparent base material 22b is, for example, 0.9 mm to 1.1 mm in thickness.

For example, photopolymer is applied to one of the principal surfaces of the first transparent film layer forming base material 30a (the surface adjacent to the first transparent film layer) using a spin coat technique and is dried as necessary. Thus, the recording material layer 14 is formed on the first transparent film layer 13a. Thereafter, one of the principal surfaces of the second transparent film layer forming base material 30b (the surface adjacent to the second transparent film layer) is bonded to the recording material layer 14 formed on the first transparent film layer 13a. In this manner, the structure 31 having the recording material layer 14 sandwiched between one of the principal surfaces of the first transparent film layer forming base material 30a and one of the principal surfaces of the second transparent film layer forming base material 30b is formed.

### (Formation of Hologram (Initialization Process))

Subsequently, as illustrated in FIG. 2C, continuous parallel light beams L1 and L2 each having a wavelength of, for example, 405 nm are emitted into the recording material layer 14 through the two principal surfaces of the structure 31 in opposite directions. In this manner, a hologram (a fringe pattern) H is formed in the entire or part of recording material layer 14.

### (Fixing)

Subsequently, in a fixing phase, fixing (a light emitting process) is performed so as to stabilize the hologram H.

### (De-Bonding of Transparent Base Material)

Subsequently, as illustrated in FIG. 3A, an adhesion interface between the film adhesion layer 21a and the first transparent film layer 13a is de-bonded. Similarly, an adhesion interface between the film adhesion layer 21b and the second transparent film layer 13b is de-bonded. In this manner, as illustrated in FIG. 3B, a hologram member 32 can be obtained. The hologram member 32 is formed by sandwiching the recording material layer 14 between the first transparent film layer 13a and the second transparent film layer 13b.

### (Bonding of Hologram Member)

Subsequently, as illustrated in FIG. 3C, the base plate 11 with a bumpy surface having a reflection layer and a selective reflection layer formed thereon is prepared. The adhesion layer 12 having a thickness of, for example, 15 μm is formed on the bumpy surface of the base plate 11. Thereafter, the hologram member 32 is bonded to the base plate 11 with the adhesion layer 12 therebetween. In this manner, as illustrated in FIG. 3D, a desired optical recording medium can be produced.

Note that when data is recorded in the optical recording medium, an erase mark is formed in the recording material layer 14 having a fringe pattern formed through the initialization process of the optical recording medium. The erase mark is formed by, for example, focusing a beam at a desired position in the recording material layer 14 and emitting a laser beam in accordance with data to be recorded. In addition, when information is reproduced and if a reading beam is emitted to a hologram, a reproduction beam is returned. However, if the reading beam is emitted to a portion in which the hologram is destroyed, any reproduction beam is not returned. Thus, recorded 1-bit data (“0” or “1”) can be obtained.

According to the first example of the method for manufacturing the optical recording medium of the present technology, by forming the structure 31 in a hologram formation stage, the flatness (the planarity) of the recording material layer can be maintained and, thus, desired wavefront aberration can be obtained. In addition, by removing the transparent base material of the structure 31, the thickness restriction of the optical recording medium in recording and reproducing data can be overcome. For example, the optical parameters of a BD can be also satisfied.

Since the recording material layer 14 is sandwiched between base materials (the transparent film layer forming base materials) each having rigidity provided by its sufficient thickness, deformation of the recording material layer 14 caused by an internal stress and an external stress (significant strain) of the recording material layer 14 can be prevented and, thus, the flatness of the recording material layer 14 can be maintained. Accordingly, a stable hologram (a stable diffracting grating) can be formed. In addition, by preventing exposure of the recording material layer 14 to oxygen until fixing is completed, deterioration of a hologram can be prevented. For example, if the recording material layer 14 is exposed to oxygen after a hologram is formed and before fixing starts, the hologram is deteriorated.

By forming the structure 31 having the light cure adhesive (the film adhesion layer) and the transparent film layer, the transparent base material can be smoothly de-bonded. At that time, since the recording material layer 14 is sandwiched between the first transparent film layer 13a and the second transparent film layer 13b, plastic deformation of the recording material layer 14 having a hologram formed therein can be prevented. According to the first example of the method for manufacturing an optical recording medium of the present technology, a stable hologram can be formed at low cost, and the formed hologram can have good keeping quality.

### Second Example of Method for Manufacturing Optical Recording Medium

A second example of the method for manufacturing an optical recording medium according to the first exemplary embodiment of the present technology is described next. For example, the second example of a method for manufacturing an optical recording medium is employed when manufacturing an optical recording medium that uses a positive micro-hologram method as a data recording method.

### (Formation of Transparent Film Layer Base Material)

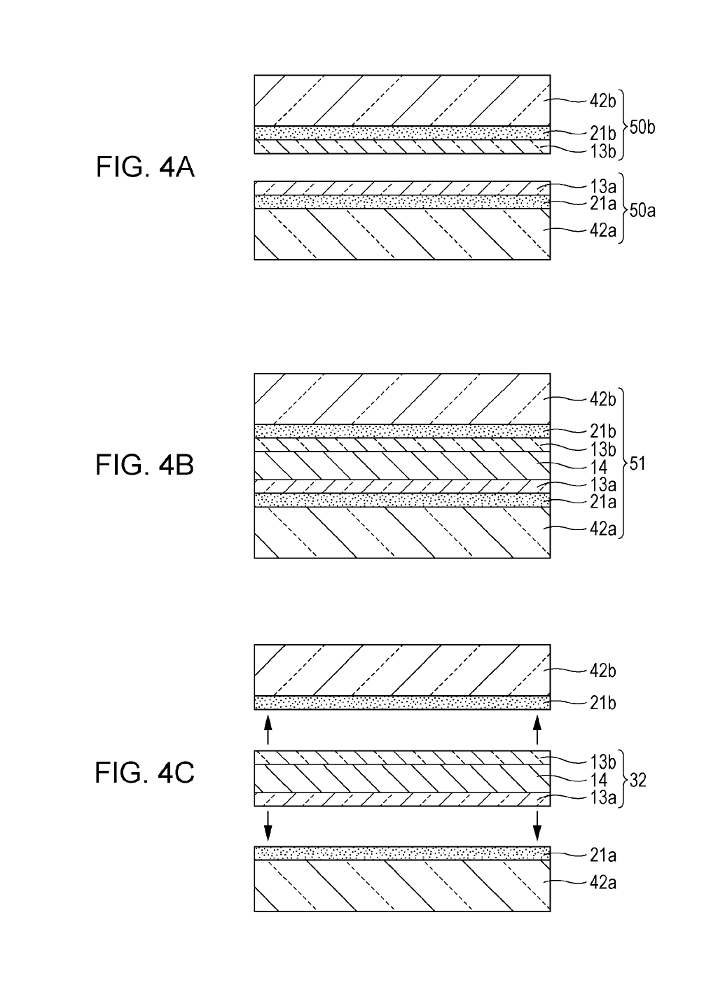

As illustrated in FIG. 4A, a first transparent film layer forming base material 50a is formed first. For example, by forming the film adhesion layer 21a on one of the principal surfaces of a base material 42a and forming the first transparent film layer 13a on top of the film adhesion layer 21a, the first transparent film layer forming base material 30a is formed.

Similarly, a second transparent film layer forming base material 50b is formed. For example, by forming the film adhesion layer 21b on one of the principal surfaces of a base material 42b and forming the second transparent film layer 13b on the film adhesion layer 21b, the second transparent film layer forming base material 30b is formed.

Each of the base material 42a and the base material 42b has, for example, a disk shape. In addition, a material having rigidity that is higher than that of the recording material layer 14 is selected as the base material 42a and the base material 42b. In this manner, deformation of the recording material layer 14 can be prevented. For example, each of the base material 42a and the base material 42b has a thickness that is sufficiently greater than that of the recording material layer 14 and, thus, has rigidity that is higher than that of the recording material layer 14. Alternatively, the base material 42a and the base material 42b are formed from a material having rigidity that is higher than that of the recording material layer 14 and, thus, have rigidity that is higher than that of the recording material layer 14. Still alternatively, each of the base material 42a and the base material 42b has a thickness that is sufficiently greater than that of the recording material layer 14 and, in addition, the base material 42a and the base material 42b are formed from a material having rigidity that is higher than that of the recording material layer 14. Thus, each of the base material 42a and the base material 42b can have rigidity that is higher than that of the recording material layer 14. Note that the base material 42a and the base material 42b may be transparent, such as a glass base plate. However, the base material 42a and the base material 42b may be non-transparent.

### (Formation of Recording Material Layer)

As illustrated in FIG. 4B, the recording material layer 14 is formed between one of the principal surfaces of the first transparent film layer forming base material 50a (the surface adjacent to the first transparent film layer) and one of the principal surfaces of the second transparent film layer forming base material 50b (the surface adjacent to the second transparent film layer). In this manner, a disc-shaped structure 51 having the recording material layer 14 sandwiched between one of the principal surfaces of the first transparent film layer forming base material 50a and one of the principal surfaces of the second transparent film layer forming base material 50b is formed.

### (De-Bonding of Base Material)

As illustrated in FIG. 4C, an adhesion interface between the film adhesion layer 21a and the first transparent film layer 13a is de-bonded. Similarly, an adhesion interface between the film adhesion layer 21b and the second transparent film layer 13b is de-bonded. In this manner, a hologram member 32 can be obtained. The hologram member 32 is formed by sandwiching the recording material layer 14 between the first transparent film layer 13a and the second transparent film layer 13b.

### (Bonding of Hologram Member)

Subsequently, a base plate 11 with a bumpy surface having a reflection layer and a selective reflection layer formed therein is prepared. The adhesion layer 12 is formed on the bumpy surface of the base plate 11. Thereafter, the hologram member 32 is bonded to the base plate 11 with the adhesion layer 12 therebetween. In this manner, a desired optical recording medium can be produced.

Note that when data is recorded in the optical recording medium, a fringe pattern of light is locally formed in a portion of the recording material layer 14 in which data is to be recorded. In this manner, the fringe pattern is formed as a record mark of a hologram. In addition, when information is reproduced and if a reading beam is emitted to a hologram, a reproduction beam is returned. However, if the reading beam is emitted to a portion other than a hologram, any reproduction beam is not returned. Thus, recorded 1-bit data (“0” or “1”) can be obtained.

According to the second example of the method for manufacturing the optical recording medium of the present technology, since the recording material layer 14 is sandwiched by base materials (the transparent film layer forming base materials) having rigidity provided by its sufficient thickness, deformation of the recording material layer 14 caused by an internal stress and an external stress (significant strain) of the recording material layer 14 can be prevented and, thus, the flatness of the recording material layer 14 can be maintained. Accordingly, a stable hologram can be formed.

By forming the structure 51 having the light cure adhesive (the film adhesion layer) and the transparent film layer, the base material can be smoothly de-bonded. At that time, since the recording material layer 14 is sandwiched between the first transparent film layer 13a and the second transparent film layer 13b, plastic deformation of the recording material layer 14 having a hologram formed therein can be prevented.

### 2. Other Exemplary Embodiments

It should be understood that this technology is not intended to be unduly limited by the above-described embodiments, but various modifications may be made without departing from the spirit and scope of the technology.

For example, the values, the structures, the shapes, the materials, the raw materials, and the manufacturing processes described in the embodiments above are only illustrative. Different values, structures, shapes, materials, raw materials, and manufacturing processes may be employed as necessary.

In addition, the configuration, the methods, the processes, the shapes, the materials, and the values described in the embodiments above can be combined in any way without departing from the spirit and scope of the technology.

Note that the stacking structure of an optical disk is not limited to that described above. For example, any stacking structure that includes the stacking structure of the present technology (i.e., the stacking structure having the recording material layer 14 sandwiched between the first transparent film layer 13a and the second transparent film layer 13b) can be employed. Furthermore, an additional layer may be provided as necessary.

The present technology can have the following configurations:

(1) an optical recording medium including a first transparent film layer, a second transparent film layer, and a recording material layer sandwiched by the first transparent film layer and the second transparent film layer, where the recording material layer includes a hologram recording material,

(2) the optical recording medium described in (1), in which a thickness of the first transparent film layer is the same or substantially the same as a thickness of the second transparent film layer,

(3) the optical recording medium described in one of (1) or (2) further including a base plate having one of principal surfaces having the first transparent film layer, the second transparent film layer, and the recording material layer thereon,

(4) the optical recording medium described in (3), in which the first transparent film layer is bonded to the one of the principal surfaces of the base plate with an adhesion layer therebetween,

(5) the optical recording medium described in any one of (1) to (4), in which the hologram recording material is photopolymer,

(6) the optical recording medium described in any one of (1) to (5), in which the first transparent film layer and the second transparent film layer are low refractive index transparent resin films having a resistance to the recording material layer and high adhesion to the recording material layer,

(7) the optical recording medium described in (6), in which the transparent resin film is an Arton film,

(8) a method for manufacturing an optical recording medium, including forming a first transparent film layer forming base material by bonding a first transparent film layer to one of principal surfaces of a first base material with a first adhesion layer therebetween, forming a second transparent film layer forming base material by bonding a second transparent film layer to one of principal surfaces of a second base material with a second adhesion layer therebetween, forming a recording material layer including a hologram recording material between a principal surface of the first transparent film layer forming base material adjacent to the first transparent film layer and a principal surface of the second transparent film layer forming base material adjacent to the second transparent film layer, forming, after the recording material layer is formed, a member having the recording material layer formed between the first transparent film layer and the second transparent film layer by de-bonding a first adhesion interface between the first transparent film layer and the first adhesion layer and de-bonding a second adhesion interface between the second transparent film layer and the second adhesion layer, and bonding the member to one of principal surfaces of a base plate,

(9) the method for manufacturing an optical recording medium described in (8), in which a thickness of the first transparent film layer is the same or substantially the same as a thickness of the second transparent film layer,

(10) the method for manufacturing an optical recording medium described in (8) or (9), in which the first base material and the second base material are transparent, and each of the first adhesion interface and the second adhesion interface is de-bonded after a hologram is formed in the recording material layer,

(11) the method for manufacturing an optical recording medium described in any one of (8) to (10), in which each of the first base material and the second base material serves as a base plate having rigidity higher than rigidity of the recording material layer,

(12) the method for manufacturing an optical recording medium described in (11), in which the base plate has a thickness greater than a thickness of the recording material layer,

(13) the method for manufacturing an optical recording medium described in any one of (8) to (12), in which each of the first base material and the second base material is a glass base plate,

(14) the method for manufacturing an optical recording medium described in any one of (8) to (13), in which each of the first transparent film layer and the second transparent film layer is a low refractive index transparent resin film having a resistance to the recording material layer, high adhesion to the recording material layer, and high peelability from the adhesion layer,

(15) the method for manufacturing an optical recording medium described in (11), in which the transparent resin film is an Arton film, and

(16) the method for manufacturing an optical recording medium described in any one of (8) to (15), in which a material of each of the first adhesion layer and the second adhesion layer is a light cure adhesive.

The present disclosure contains subject matter related to that disclosed in Japanese Priority Patent Application JP 2012-176227 filed in the Japan Patent Office on Aug. 8, 2012, the entire contents of which are hereby incorporated by reference.

What is claimed is:

1. An optical recording medium comprising:
a first transparent film layer;
a second transparent film layer; and
a recording material layer sandwiched between the first transparent film layer and the second transparent film layer, the recording material layer including a hologram recording material.

2. The optical recording medium according to claim 1, wherein a thickness of the first transparent film layer is the same or substantially the same as a thickness of the second transparent film layer.

3. The optical recording medium according to claim 1, further comprising:
a base plate having one of principal surfaces having the first transparent film layer, the second transparent film layer, and the recording material layer thereon.

4. The optical recording medium according to claim 3, wherein the first transparent film layer is bonded to the one of the principal surfaces of the base plate with an adhesion layer therebetween.

5. The optical recording medium according to claim 1, wherein the hologram recording material is photopolymer.

6. The optical recording medium according to claim 1, wherein each of the first transparent film layer and the second transparent film layer is a low refractive index transparent resin film having a resistance to the recording material layer and high adhesion to the recording material layer.

7. The optical recording medium according to claim 6, wherein the transparent resin film is an Arton film.

8. A method for manufacturing an optical recording medium, comprising:
forming a first transparent film layer forming base material by bonding a first transparent film layer to one of principal surfaces of a first base material with a first adhesion layer therebetween;
forming a second transparent film layer forming base material by bonding a second transparent film layer to one of principal surfaces of a second base material with a second adhesion layer therebetween;
forming a recording material layer including a hologram recording material between a principal surface of the first transparent film layer forming base material adjacent to the first transparent film layer and a principal surface of the second transparent film layer forming base material adjacent to the second transparent film layer;
forming, after the recording material layer is formed, a member having the recording material layer formed between the first transparent film layer and the second transparent film layer by de-bonding a first adhesion interface between the first transparent film layer and the first adhesion layer and de-bonding a second adhesion interface between the second transparent film layer and the second adhesion layer; and
bonding the member to one of principal surfaces of a base plate.

9. The method for manufacturing an optical recording medium according to claim 8, wherein a thickness of the first transparent film layer is the same or substantially the same as a thickness of the second transparent film layer.

10. The method for manufacturing an optical recording medium according to claim 8, wherein the first base material and the second base material are transparent, and
wherein each of the first adhesion interface and the second adhesion interface is de-bonded after a hologram is formed in the recording material layer.

11. The method for manufacturing an optical recording medium according to claim 8, wherein each of the first base material and the second base material serves as a base plate having rigidity higher than rigidity of the recording material layer.

12. The method for manufacturing an optical recording medium according to claim 11, wherein the base plate has a thickness greater than a thickness of the recording material layer.

13. The method for manufacturing an optical recording medium according to claim 8, wherein each of the first base material and the second base material is a glass base plate.

14. The method for manufacturing an optical recording medium according to claim 8, wherein each of the first transparent film layer and the second transparent film layer is a low refractive index transparent resin film having a resistance to the recording material layer, high adhesion to the recording material layer, and high peelability from the adhesion layer.

15. The method for manufacturing an optical recording medium according to claim 14, wherein the transparent resin film is an Arton film.

16. The method for manufacturing an optical recording medium according to claim 8, wherein a material of each of the first adhesion layer and the second adhesion layer is a light cure adhesive.
